(19) United States
(12) Patent Application Publication
(10) Pub. No.: US 2016/0295439 A1
(43) Pub. Date: Oct. 6, 2016

(54) MEASUREMENT PROCEDURES DURING CONNECTED MODE DISCONTINUOUS RECEPTION CYCLE BASED ON BLOCKING LOW PRIORITY DATA ACTIVITIES

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/813,100

(22) Filed: Jul. 29, 2015

Related U.S. Application Data
(60) Provisional application No. 62/141,743, filed on Apr. 1, 2015.

(51) Int. Cl. H04W 24/10; H04W 76/04

(52) U.S. Cl. CPC H04W 24/10; H04W 76/048

(57) ABSTRACT

A user equipment (UE) improves measurement procedures during a communication cycle, such as a connected mode discontinuous reception cycle (C-DRX cycle). In one instance, the UE enters a C-DRX off duration during a C-DRX cycle of an ongoing communication. The UE then stops background activity until a start of a C-DRX on duration of a next C-DRX cycle when a signal quality of a serving radio access technology (RAT) is below a predefined threshold.

### CROSS-REFERENCE TO RELATED APPLICATION

This application claims the benefit under 35 U.S.C. §119(e) to U.S. Provisional Patent Application No. 62/141,743, entitled “METHOD TO DETERMINE TUNE AWAY FOR MULTI-SUBSCRIBER IDENTITY MODULE MULTI-STANDBY DEVICE,” filed on Apr. 1, 2015, in the names of YANG, et al., the disclosure of which is expressly incorporated by reference herein in its entirety.

### BACKGROUND

1. Field

Aspects of the present disclosure relate generally to wireless communication systems, and more particularly, to performing measurement procedures during a connected mode discontinuous reception (C-DRX) cycle when background activities are ongoing.

2. Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method of wireless communication includes entering a connected mode discontinuous reception cycle (C-DRX) off duration during a C-DRX cycle of an ongoing communication. The method also includes stopping background activity until a start of a C-DRX on duration of a next C-DRX cycle when a signal quality of a serving radio access technology (RAT) is below a predefined threshold.

According to one aspect of the present disclosure, a method for wireless communication includes detecting a signal quality of a serving radio access technology (RAT). The method further includes determining whether to perform measurements on a non-serving RAT during a sleep mode of an ongoing communication based on the detected signal quality.

According to one aspect of the present disclosure, a method for wireless communication includes detecting whether a measurement gap period for measurement of a non-serving radio access technology (RAT) is sufficient to detect timing of the non-serving RAT. The method further includes determining whether to perform measurements on the non-serving RAT during a sleep mode of an ongoing communication based on the sufficiency of the detected gap period.

According to another aspect of the present disclosure, an apparatus for wireless communication includes means for entering a connected mode discontinuous reception cycle (C-DRX) off duration during a C-DRX cycle of an ongoing communication. The apparatus may also include means for stopping background activity until a start of a C-DRX on duration of a next C-DRX cycle when a signal quality of a serving radio access technology (RAT) is below a predefined threshold.

According to another aspect of the present disclosure, an apparatus for wireless communication includes means for detecting a signal quality of a serving radio access technology (RAT). The apparatus may also include means for determining whether to perform measurements on a non-serving RAT during a sleep mode of an ongoing communication based on the detected signal quality.

According to another aspect of the present disclosure, an apparatus for wireless communication includes means for detecting whether a measurement gap period for measurement of a non-serving radio access technology (RAT) is sufficient to detect timing of the non-serving RAT. The apparatus may also include means for determining whether to perform measurements on the non-serving RAT during a sleep mode of an ongoing communication based on the sufficiency of the detected gap period.

Another aspect discloses an apparatus for wireless communication and includes a memory, a transceiver and at least one processor coupled to the memory. The processor(s) is configured to cause a user equipment (UE) to enter a connected mode discontinuous reception cycle (C-DRX) off duration during a C-DRX cycle of an ongoing communication. The processor(s) is also configured to stop background activity until a start of a C-DRX on duration of a next C-DRX cycle when a signal quality of a serving radio access technology (RAT) is below a predefined threshold.

Yet another aspect discloses a computer program product for wireless communications in a wireless network having a non-transitory computer-readable medium. The computer-readable medium has non-transitory program code recorded thereon which, when executed by the processor(s), causes the processor(s) to cause a user equipment (UE) to enter a connected mode discontinuous reception cycle (C-DRX) off duration during a C-DRX cycle of an ongoing communication. The program code also causes the processor(s) to stop background activity until a start of a C-DRX on duration of a next C-DRX cycle when a signal quality of a serving radio access technology (RAT) is below a predefined threshold.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in LTE.

FIG. 3 is a diagram illustrating an example of an uplink frame structure in LTE.

FIG. 4 is a block diagram conceptually illustrating an example of a telecommunications system employing a time division synchronous code division multiple access standard.

FIG. 5 is a block diagram conceptually illustrating an example of a frame structure for a time division synchronous code division multiple access carrier.

FIG. 6 is a block diagram illustrating an example of a global system for mobile communications (GSM) frame structure.

FIG. 7 is a block diagram conceptually illustrating an example of a base station in communication with a user equipment (UE) in a telecommunications system.

FIG. 8 is a block diagram illustrating the timing of channel carriers according to aspects of the present disclosure.

FIG. 9 is a diagram illustrating network coverage areas according to aspects of the present disclosure.

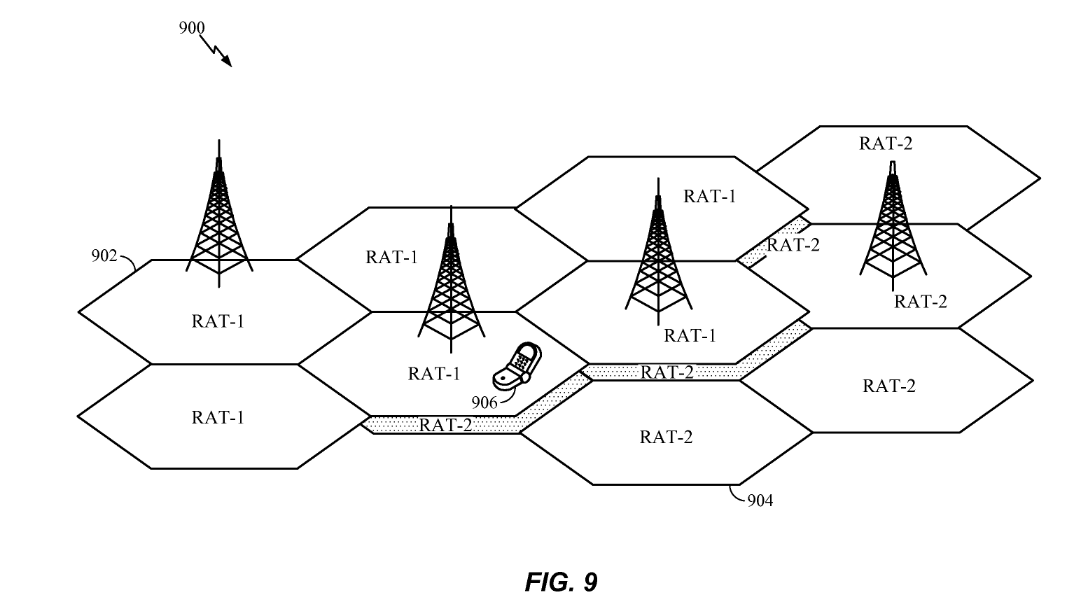

FIG. 10 is a block diagram illustrating a wireless communication network in accordance with aspects of the present disclosure.

FIG. 11 is an exemplary call flow diagram illustrating a signaling procedure for handover of a user equipment communicating according to a single radio voice call continuity (SRVCC) procedure.

FIG. 12 is a flow diagram illustrating an example decision process for search and measurement of neighbor cells.

FIG. 13 illustrates an exemplary discontinuous reception communication cycle.

FIG. 14 is a flow diagram illustrating a method for adjusting a tune away procedure according to one aspect of the present disclosure.

FIG. 15 is a flow diagram illustrating a method for performing measurements during a discontinuous reception cycle according to one aspect of the present disclosure.

FIG. 16 is a flow diagram illustrating a method for performing measurements during a discontinuous reception cycle based on signal quality of serving/neighbor cells according to one aspect of the present disclosure.

FIG. 17 is a flow diagram illustrating a method for performing measurements during a discontinuous reception cycle based on a measurement gap according to one aspect of the present disclosure.

FIG. 18 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

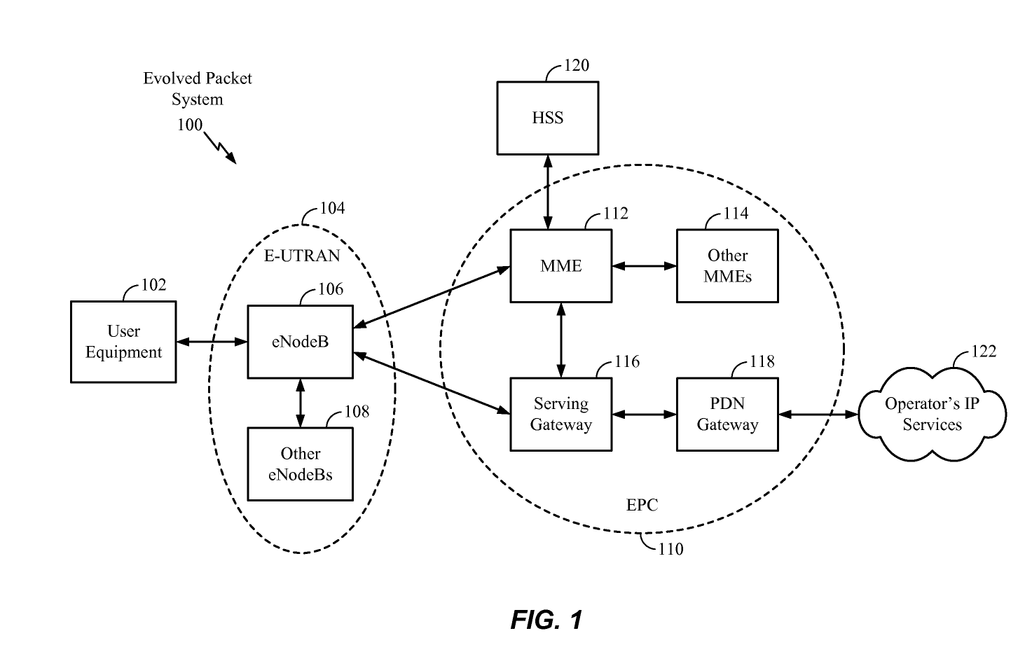

FIG. 1 is a diagram illustrating a network architecture 100 of a long-term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

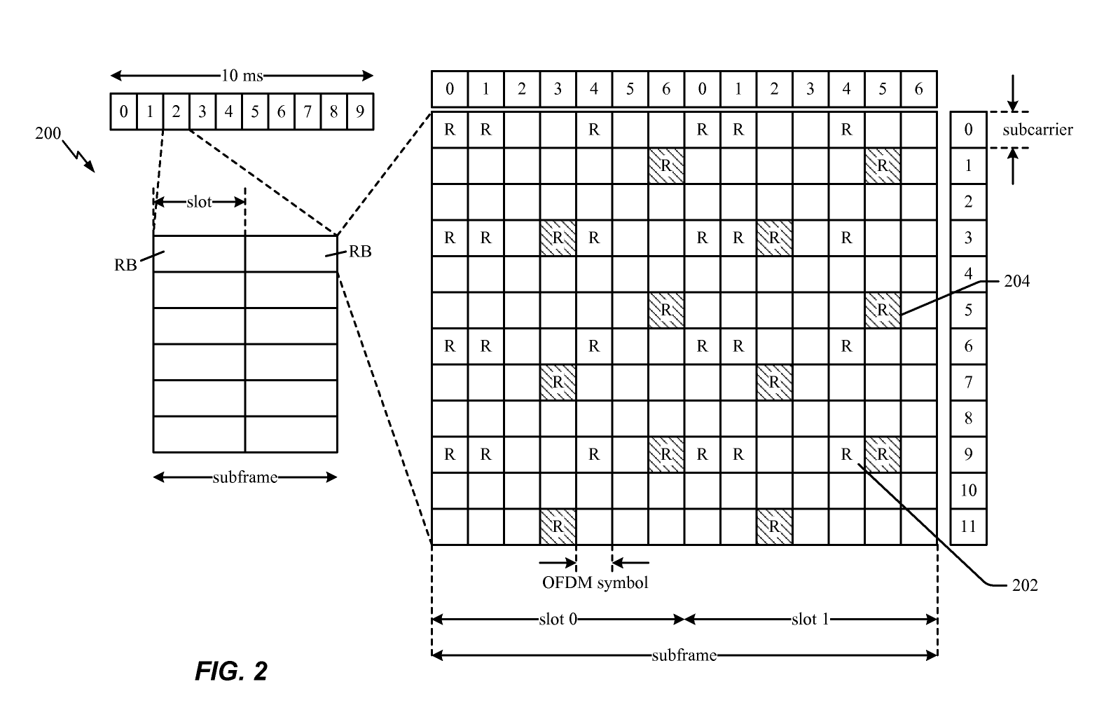

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

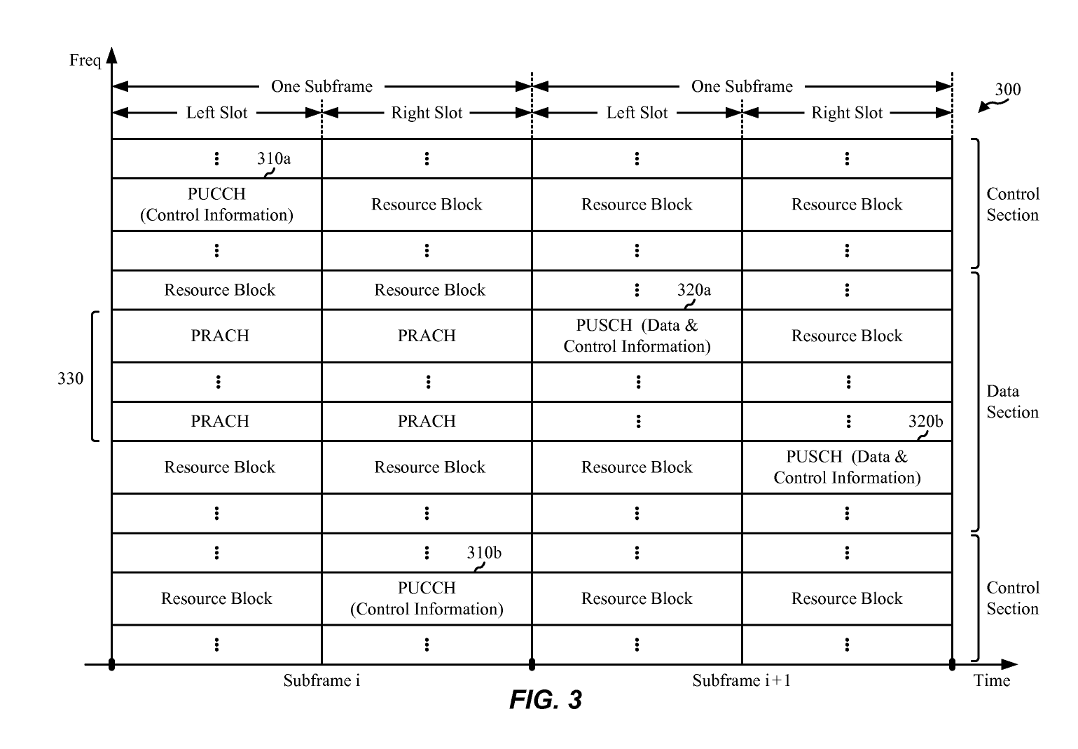

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

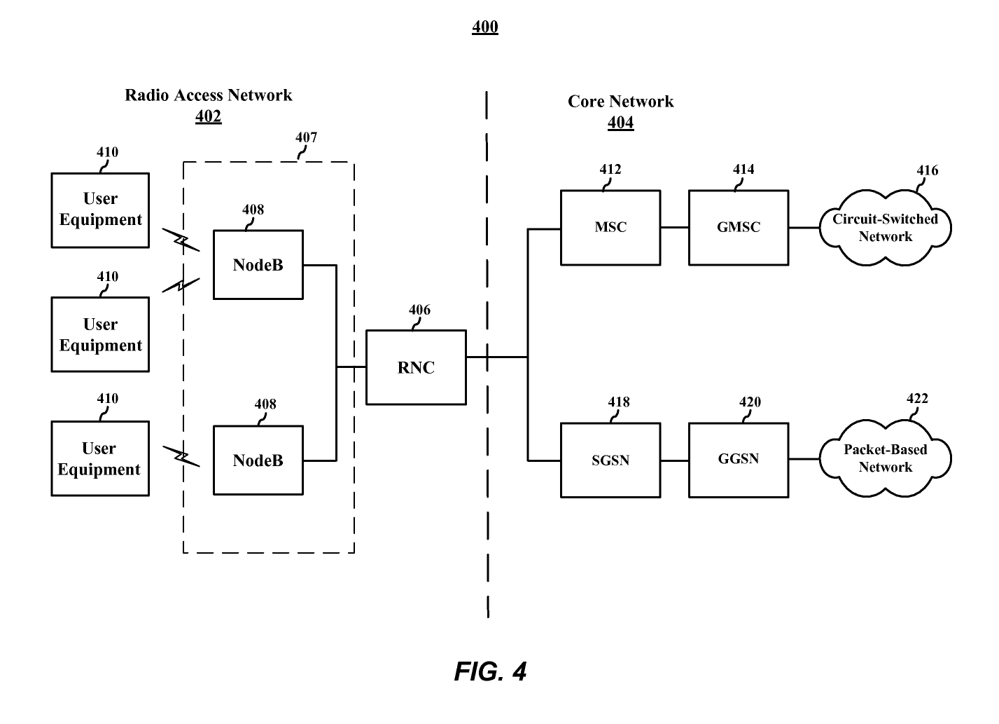

Turning now to FIG. 4, a block diagram is shown illustrating an example of a telecommunications system 400. The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a (radio access network) RAN 402 (e.g., UTRAN) that provides various wireless services including telephony, video, data, messaging, broadcasts, and/or other services. The RAN 402 may be divided into a number of radio network subsystems (RNSs) such as an RNS 407, each controlled by a radio network controller (RNC), such as an RNC 406. For clarity, only the RNC 406 and the RNS 407 are shown; however, the RAN 402 may include any number of RNCs and RNSs in addition to the RNC 406 and RNS 407. The RNC 406 is an apparatus responsible for, among other things, assigning, reconfiguring and releasing radio resources within the RNS 407. The RNC 406 may be interconnected to other RNCs (not shown) in the RAN 402 through various types of interfaces such as a direct physical connection, a virtual network, or the like, using any suitable transport network.

The geographic region covered by the RNS 407 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 408 are shown; however, the RNS 407 may include any number of wireless nodeBs. The nodeBs 408 provide wireless access points to a core network 404 for any number of mobile apparatuses. For illustrative purposes, three UEs 410 are shown in communication with the nodeBs 408. The downlink (DL), also called the forward link, refers to the communication link from a nodeB to a UE, and the uplink (UL), also called the reverse link, refers to the communication link from a UE to a nodeB.

The core network 404, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 404 supports circuit-switched services with a mobile switching center (MSC) 412 and a gateway MSC (GMSC) 414. One or more RNCs, such as the RNC 406, may be connected to the MSC 412. The MSC 412 is an apparatus that controls call setup, call routing, and UE mobility functions. The MSC 412 also includes a visitor location register (VLR) (not shown) that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR to determine the UE's location and forwards the call to the particular MSC serving that location.

The core network 404 also supports packet-data services with a serving GPRS support node (SGSN) 418 and a gateway GPRS support node (GGSN) 420. General packet radio service (GPRS) is designed to provide packet-data services at speeds higher than those available with standard GSM circuit-switched data services. The GGSN 420 provides a connection for the RAN 402 to a packet-based network 422. The packet-based network 422 may be the Internet, a private data network, or some other suitable packet-based network. The primary function of the GGSN 420 is to provide the UEs 410 with packet-based network connectivity. Data packets are transferred between the GGSN 420 and the UEs 410 through the SGSN 418, which performs primarily the same functions in the packet-based domain as the MSC 412 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 408 and a UE 410, but divides uplink and downlink transmissions into different time slots in the carrier.

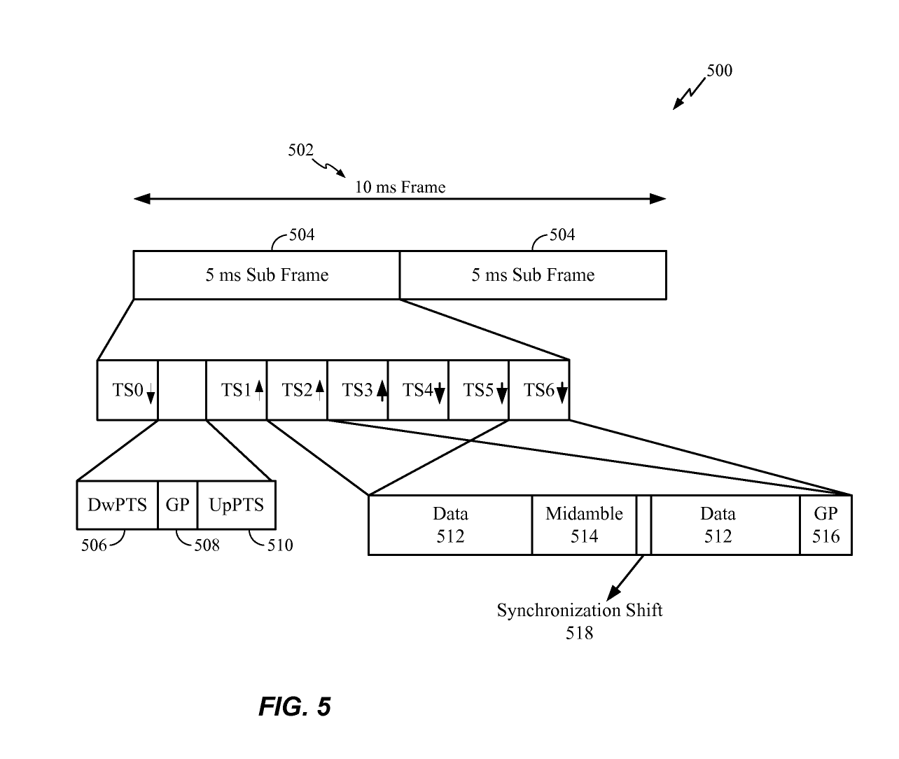

FIG. 5 shows a frame structure 500 for a TD-SCDMA carrier. The TD-SCDMA carrier, as illustrated, has a frame 502 that is 10 ms in length. The chip rate in TD-SCDMA is 1.28 Mcps. The frame 502 has two 5 ms subframes 504, and each of the subframes 504 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 506, a guard period (GP) 508, and an uplink pilot time slot (UpPTS) 510 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 512 (each with a length of 352 chips) separated by a midamble 514 (with a length of 144 chips) and followed by a guard period (GP) 516 (with a length of 16 chips). The midamble 514 may be used for features, such as channel estimation, while the guard period 516 may be used to avoid inter-burst interference. Also transmitted in the data portion is some Layer 1 control information, including synchronization shift (SS) bits 518. Synchronization shift bits 518 only appear in the second part of the data portion. The synchronization shift bits 518 immediately following the midamble can indicate three cases: decrease shift, increase shift, or do nothing in the upload transmit timing. The positions of the synchronization shift bits 518 are not generally used during uplink communications.

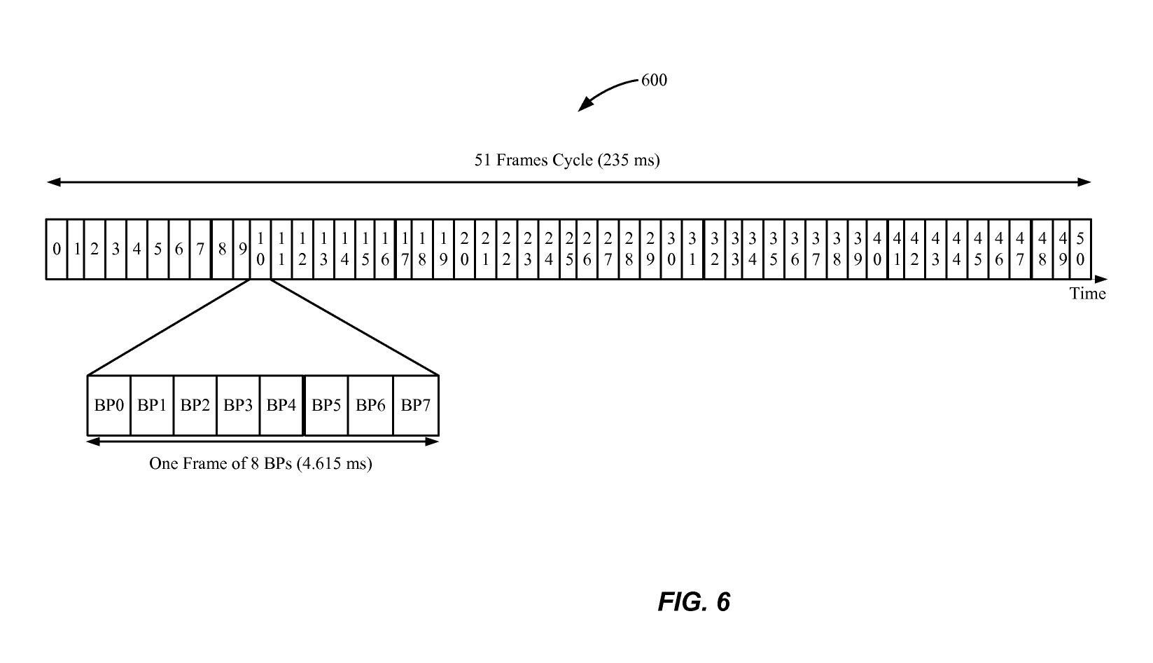

FIG. 6 is a block diagram illustrating an example of a GSM frame structure 600. The GSM frame structure 600 includes fifty-one frame cycles for a total duration of 235 ms. Each frame of the GSM frame structure 600 may have a frame length of 4.615 ms and may include eight burst periods, BP0-BP7.

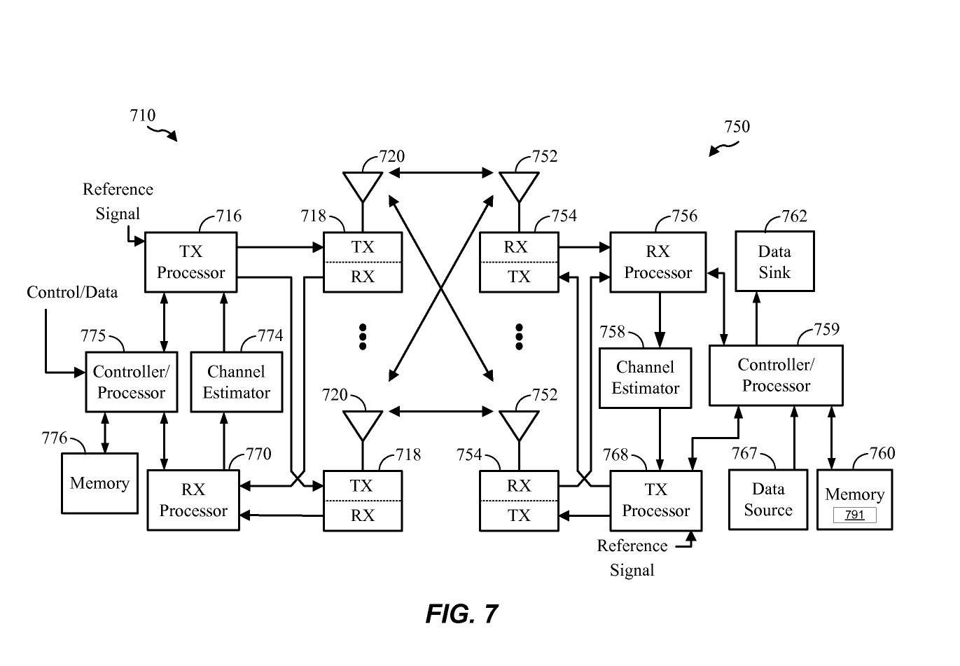

FIG. 7 is a block diagram of a base station (e.g., eNodeB or nodeB) 710 in communication with a UE 750 in an access network. In the downlink, upper layer packets from the core network are provided to a controller/processor 775. The controller/processor 775 implements the functionality of the L2 layer. In the downlink, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (e.g., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter (TX) 718. Each transmitter (TX) 718 modulates a radio frequency (RF) carrier with a respective spatial stream for transmission.

At the UE 750, each receiver (RX) 754 receives a signal through its respective antenna 752. Each receiver (RX) 754 recovers information modulated onto an RF carrier and provides the information to the receiver (RX) processor 756. The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 710. These soft decisions may be based on channel estimates computed by the channel estimator 758. The soft decisions are then decoded and deinterleaved to recover the data and control signals that were originally transmitted by the base station 710 on the physical channel. The data and control signals are then provided to the controller/processor 759.

The controller/processor 759 implements the L2 layer. The controller/processor can be associated with a memory 760 that stores program codes and data. The memory 760 may be referred to as a computer-readable medium. In the uplink transmission, the controller/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the uplink transmission, a data source 767 is used to provide upper layer packets to the controller/processor 759. The data source 767 represents all protocol layers above the L2 layer. Similar to the functionality described in connection with the downlink transmission by the base station 710, the controller/processor 759 implements the L2 layer for the user plane and the control plane by providing header compression, ciphering, packet segmentation and reordering, and multiplexing between logical and transport channels based on radio resource allocations by the base station 710. The controller/processor 759 is also responsible for HARQ operations, retransmission of lost packets, and signaling to the base station 710.

Channel estimates derived by a channel estimator 758 from a reference signal or feedback transmitted by the base station 710 may be used by the TX processor 768 to select the appropriate coding and modulation schemes, and to facilitate spatial processing. The spatial streams generated by the TX processor 768 are provided to different antenna 752 via separate transmitters (TX) 754. Each transmitter (TX) 754 modulates an RF carrier with a respective spatial stream for transmission.

The uplink transmission is processed at the base station 710 in a manner similar to that described in connection with the receiver function at the UE 750. Each receiver (RX) 718 receives a signal through its respective antenna 720. Each receiver (RX) 718 recovers information modulated onto an RF carrier and provides the information to a RX processor 770. The RX processor 770 may implement the L1 layer.

The controller/processor 775 implements the L2 layer. The controllers/processors 775 and 759 can be associated with memories 776 and 760, respectively that store program codes and data. For example, the controllers/processors 775 and 759 may provide various functions including timing, peripheral interfaces, voltage regulation, power management, and other control functions. The memories 776 and 760 may be referred to as a computer-readable media. For example, the memory 760 of the UE 750 may store a wireless communication module 791 which, when executed by the controller/processor 759, configures the UE 750 to perform aspects of the present disclosure.

In the uplink transmission, the controller/processor 775 provides demultiplexing between transport and logical channels, packet reassembly, deciphering, header decompression, control signal processing to recover upper layer packets from the UE 750. Upper layer packets from the controller/processor 775 may be provided to the core network. The controller/processor 775 is also responsible for error detection using an ACK and/or NACK protocol to support HARQ operations.

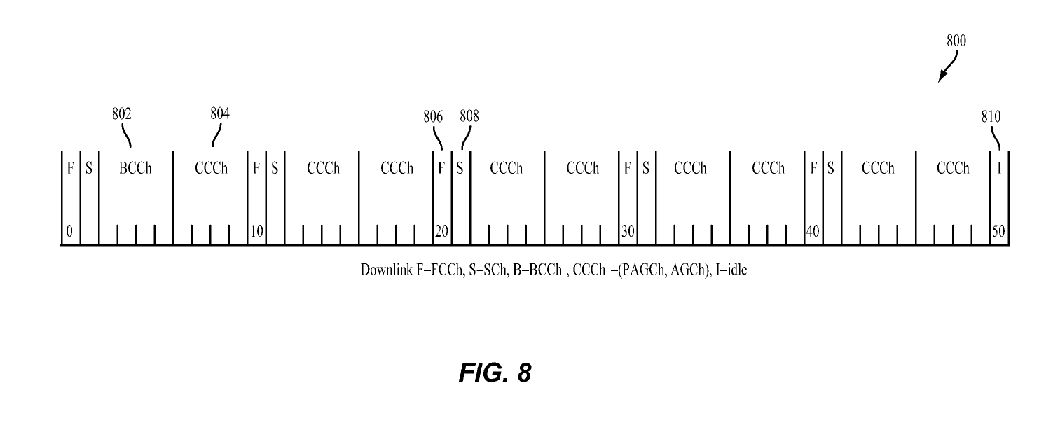

Some networks may be deployed with multiple radio access technologies. FIG. 8 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

FIG. 8 is a block diagram 800 illustrating the timing of channels according to aspects of the present disclosure. The block diagram 800 shows a broadcast control channel (BCCH) 802, a common control channel (CCCH) 804, a frequency correction channel (FCCH) 806, a synchronization channel (SCH) 808 and an idle time slot 810. The numbers at the bottom of the block diagram 800 indicate various moments in time. In one configuration, the numbers at the bottom of the block diagram 800 are in seconds. In one configuration, each block of a FCCH 806 may include eight time slots, with only the first timeslot (or TS0) used for FCCH tone detection.

The timing of the channels shown in the block diagram 800 may be determined in a BSIC identification procedure. The BSIC identification procedure may include detection of the FCCH carrier 806, based on a fixed bit sequence that is carried on the FCCH 806. FCCH tone detection is performed to find the relative timing between multiple RATs. The FCCH tone detection may be based on the SCH 808 being either a first number of frames or a second number of frames later in time than the FCCH 806. The first number of frames may be equal to 11+n·10 frames and the second number of frames may be equal to 12+n·10 frames. The dot operator represents multiplication and n can be any positive number. These equations are used to schedule idle time slots to decode the SCH. The first number of frames and the second number of frames may be used to schedule idle time slots in order to decode the SCH 808, in case the SCH 808 falls into a measurement gap or an idle time slot 810.

For FCCH tone detection in an inter RAT measurement, the FCCH may fully or partially fall within the idle time slots of the first RAT (not shown). The UE attempts to detect FCCH tones (for example, such as the FCCH 806) on the BCCH carrier of the n strongest BCCH carriers of the cells in the second RAT. The strongest cells in the second RAT may be indicated by a measurement control message. In one configuration, n is eight and the n BCCH carriers are ranked in order of the signal strength. For example, a BCCH carrier may be ranked higher than other BCCH carriers when the signal strength of the BCCH carrier is stronger than the signal strength of the other BCCH carriers. The top ranked BCCH carrier may be prioritized for FCCH tone detection.

Each BCCH carrier may be associated with a neighbor cell in the second RAT. In some instances, the UE receives a neighbor cell list including n ranked neighbor cells from a base station of the first RAT, for example, in a measurement control message. The neighbor cells in the neighbor cell list may be ranked according to signal strength. In some configurations, the n ranked neighbor cells may correspond to the n strongest BCCH carriers, such that system acquisition of the neighbor cells includes FCCH tone detection of these BCCH carriers.

In one example, the geographical area 900 includes RAT-1 cells 902 and RAT-2 cells 904. In one example, the RAT-1 cells are 2G or 3G cells and the RAT-2 cells are LTE cells. However, those skilled in the art will appreciate that other types of radio access technologies may be utilized within the cells. A user equipment (UE) 906 may move from one cell, such as a RAT-1 cell 902, to another cell, such as a RAT-2 cell 904. The movement of the UE 906 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique international mobile subscriber identity (IMSI) and service subscription information. Each SIM may be configured to operate in a particular radio access technology. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using multiple radio frequency (RF) chains to transmit and receive communications. An RF chain is a set of components used to communicate between the mobile device and the base station. The UE may also be a multi-SIM-multi-standby device, which means the UE is limited to connecting to one network at a time. In one example, a multi-SIM device includes a first SIM dedicated to operate in a first RAT using a first RF chain and a second SIM dedicated to operate in a second RAT using a second RF chain. Alternatively, the first SIM and the second SIM may share a same receive/transmit chain. As a result, communication on the first SIM may be suspended when the UE is communication on the second SIM. In one illustrative example, the multi-SIM device includes a first SIM configured to operate in fourth generation (4G) radio access technology (RAT) (e.g., LTE) and a second SIM configured to operate in a second/third generation (2G/3G) RAT. The multi-SIM device may operate in other RATS known to those skilled in the art.

When a fourth generation radio access technology subscription is in a radio resource control (RRC) connected mode without voice traffic, the dual subscriber identity module dual standby UE supports tuning away from a connected RAT for various purposes, including neighbor cell measurement, etc. The UE may attempt to schedule the tuning away to reduce the impact to ongoing communications. For example, the UE may tune away from the fourth generation RAT to the second/third generation RAT while trying to reduce amount of interruption to the fourth generation connected mode operation. As an example of the UE tuning away to check a neighboring RAT's signal, a multi-SIM, multi-standby UE periodically tunes away from LTE to perform one or more communication activities on TD-SCDMA or GSM. The TD-SCDMA communication activities may include monitoring for a page, collecting broadcast control channel (BCCH) system information blocks (SIBs), performing cell reselection, etc. If a page is detected when the UE is tuned to TD-SCDMA, the UE suspends LTE operations and transitions to TD-SCDMA. When a page is not detected on the second/third generation RAT, the UE tunes back or attempts to tune back to the fourth generation RAT and attempts to recover the original operation of the fourth generation RAT.

As noted, during a communication procedure for a first SIM, a multi-SIM multi-standby UE may tune to a second SIM to perform activities on the second SIM. As a result, the UE suspends communication on the first SIM during the tune away. For example the first SIM and the second SIM may share a same receive chain and therefore cannot communicate simultaneously. The UE may tune away to monitor for a page on the second SIM. The communication procedure may be random access channel (RACH) procedure, handover procedure or radio link failure (RLF) procedure. After the UE tunes back to the first SIM, the UE attempts to continue the communication procedure for the first SIM. In some instances, however, the attempt to continue or complete the communication procedure for the first SIM fails because a timer for the communication procedure for the first SIM has expired. The expiration of the timer causes an incomplete communication procedure on the first SIM, which results in a RAT failure event. For example, the RAT failure event may include handover failure, call setup failure or a dropped call.

### Tune Away for Multi Subscriber Identity Module Multi Standby User Equipment

Aspects of the present disclosure are directed to preventing or reducing call interruptions (e.g., dropped calls) on a multi-subscriber identity module (SIM) multi standby user equipment (UE) caused by tuning away from communications using one SIM to communications using another SIM. In one aspect of the present disclosure, the UE determines or predicts an expected duration for tuning away from a first SIM to one or more other SIMs of the UE.

In some aspect of the disclosure, the UE determines the expected duration of the tune away based on hardware and/or software capabilities of the UE. The UE further determines or identifies an expected duration (e.g., remaining time) of a timer allocated for a current communication procedure on the first SIM. For example, the remaining time includes time remaining until failure of a current event on the first RAT at a time instance of the expected tune away. The timer may be a variable timer such that the identification of the timer is dynamic.

The UE then determines whether to adjust or reschedule the tune away procedure based on the expected tune away duration and the remaining time. For example, when the UE determines that the expected duration of the tune away will cause the timer allocated for the current communication procedure on the first SIM to expire (and thus potentially result in a RAT failure event), the UE may reschedule the tune away procedure. Rescheduling the tune away procedure includes skipping the tune away procedure entirely or scheduling the tune away procedure for a different time. The UE independently reschedules the tune away procedure. The rescheduling of the tune away procedure may also include performing a short tune away to avoid causing the timer to expire when the UE tunes away. For example, the tune away period may be broken into multiple tune away periods where the short (or quick) tune away may include a fraction of the original tune away time periods. Alternatively, the UE may elect to perform a long tune away if the expected duration for tune away will not cause the timer to expire.

In one aspect of the disclosure, the first SIM is for communications with a first RAT (e.g., fourth generation (4G) RAT such as LTE) and the second SIM is for communications to a second RAT (e.g., second/third generation (2G/3G) RAT such as GSM or TD-SCDMA). Alternatively, the first and the second SIMs communicate according to a same RAT (e.g., TD-SCDMA). Thus, the first SIM and the second SIM are each assigned to a different RAT or share a same RAT.

Tune away procedures may be performed as a prelude to transitioning (e.g., handover or cell reselection) the UE from a serving RAT (e.g., first RAT) to a target RAT (e.g., second RAT). Ongoing communication on the UE may be handed over from the first RAT to a second RAT based on measurements performed on the second RAT. For example, the UE may tune away to the second RAT to perform the measurements.

After the measurements, handover may occur according to a single radio voice call continuity (SRVCC) procedure. SRVCC is a solution aimed at providing continuous voice services on packet-switched networks (e.g., LTE networks). In the early phases of LTE deployment, when UEs running voice services move out of an LTE network, the voice services can continue in the legacy circuit-switched (CS) domain using SRVCC, ensuring voice service continuity. SRVCC is a method of inter-radio access technology (IRAT) handover. SRVCC enables smooth session transfers from voice over internet protocol (VoIP) over the IP multimedia subsystem (IMS) on the LTE network to circuit-switched services in the universal terrestrial radio access network (UTRAN) or GSM enhanced date rates for GSM Evolution (EDGE) radio access network (GERAN).

LTE coverage is limited in availability. When a UE that is conducting a packet-switched voice call (e.g., voice over LTE (VoLTE) call) leaves LTE coverage or when the LTE network is highly loaded, SRVCC may be used to maintain voice call continuity from a packet-switched (PS) call to a circuit-switched call during IRAT handover scenarios. SRVCC may also be used, for example, when a UE has a circuit-switched voice preference (e.g., circuit-switched fallback (CSFB)) and packet-switched voice preference is secondary if combined attach fails. The evolved packet core (EPC) may send an accept message for PS Attach in which case a VoIP/IMS capable UE initiates a packet-switched voice call.

A UE may perform an LTE serving cell measurement. When the LTE serving cell signal strength or quality is below a threshold (meaning the LTE signal may not be sufficient for an ongoing call), the UE may report an event 2A (change of the best frequency). In response to the measurement report, the LTE network may send radio resource control (RRC) reconfiguration messages indicating 2G/3G neighbor frequencies. The RRC reconfiguration message also indicates event B1 (neighbor cell becomes better than an absolute threshold) and/or B2 (a serving RAT becomes worse than a threshold and the inter-RAT neighbor become better than another threshold). The LTE network may also allocate LTE measurement gaps. For example, the measurement gap for LTE is a 6 ms gap that occurs every 40 or 80 ms. The UE uses the measurement gap to perform 2G/3G measurements and LTE inter frequency measurements.

The measurement gap may be used for multiple IRAT measurements and inter frequency measurements. The inter frequency measurements may include measurements of frequencies of a same RAT (e.g., serving LTE). The IRAT measurements may include measurements of frequencies of a different RAT (e.g., non-serving RAT such as TD-SCDMA or GSM). In some implementations, the LTE inter frequency measurements and TD-SCDMA IRAT measurements have a higher measurement scheduling priority than GSM.

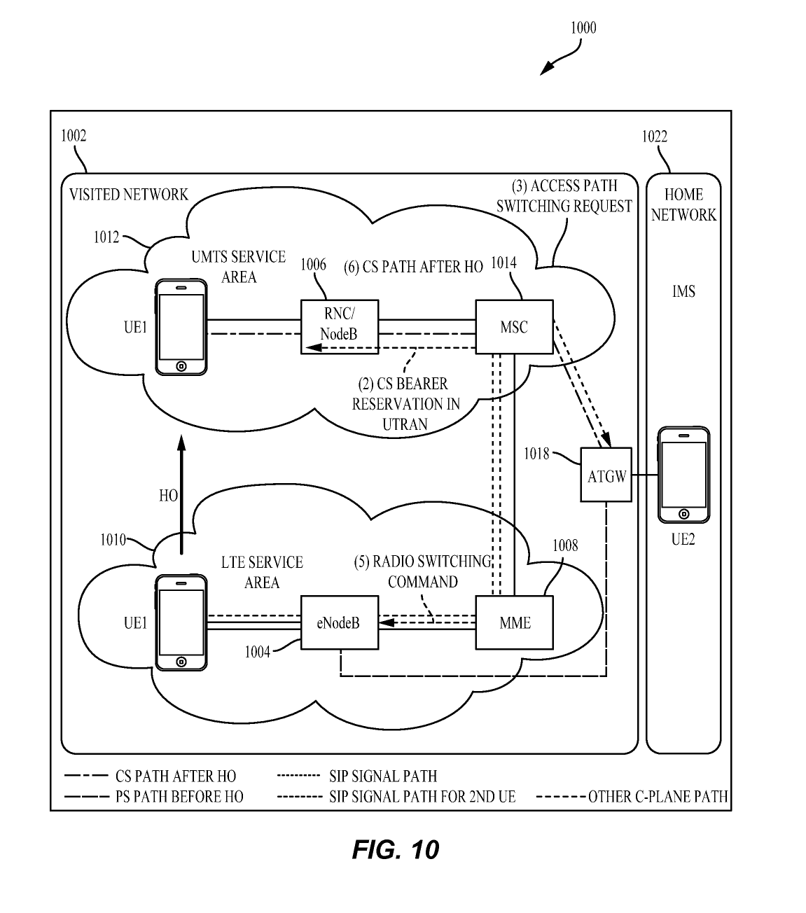

When the LTE eNodeB receives the event B1 report from the UE, the LTE eNodeB may initiate the SRVCC procedure. The SRVCC procedure may be implemented in a wireless network, such as the wireless network of FIG. 10.

FIG. 10 is a block diagram illustrating a wireless communication network 1000 in accordance with aspects of the present disclosure. Referring to FIG. 10, the wireless communication network may include a visited network 1002 and a home network 1022. The visited network 1002 may include multiple service areas. For example, as shown in FIG. 10, without limitation, the visited network 1002 may include an LTE service area 1010 and a UMTS service area 1012. A first UE (UE1) located in the LTE service area 1010 may conduct a voice call with a second UE (UE2), which is located in the home network 1022. In one aspect, UE1 may conduct a voice call (e.g., a PS call or VoLTE) with UE2 via the access transfer gateway (ATGW) 1018. The various communication links or paths are represented by solid and/or different dashed lines. The communication paths include circuit-switched (CS) path after handover (HO), packet-switched path before handover, session initiation protocol (SIP) signal path, session initiation protocol signal path for a second UE (UE2) and a communication plane (C-plane) path.

When UE1 leaves the LTE service area 1010, the LTE serving cell (eNodeB 1004) signal strength or signal quality may fall below a threshold. As such, UE1 may report an event 2A. In turn, the eNodeB 1004 may provide an RRC connection reconfiguration message to UE1. The RRC connection reconfiguration message may include measurement configuration information such as the LTE measurement gap allocation. For example, the LTE gap allocation may be such that a 6 ms measurement gap occurs every 40 ms.

Accordingly, UE1 may conduct the IRAT and inter-frequency measurements and provide a corresponding measurement report to the eNodeB 1004, which may initiate the handover of coverage to the NodeB 1006 of the UMTS service area 1012. The mobility management entity (MME) 1008 may initiate an SRVCC procedure for the handover. A switch procedure may be initiated to transfer the voice call to a circuit-switched network. An access path switching request is sent via the mobile switching center (MSC) 1014, which routes the voice call to UE2 via the access transfer gateway (ATGW) 1018. Thereafter, the call between UE1 and UE2 may be transferred to a circuit-switched call.

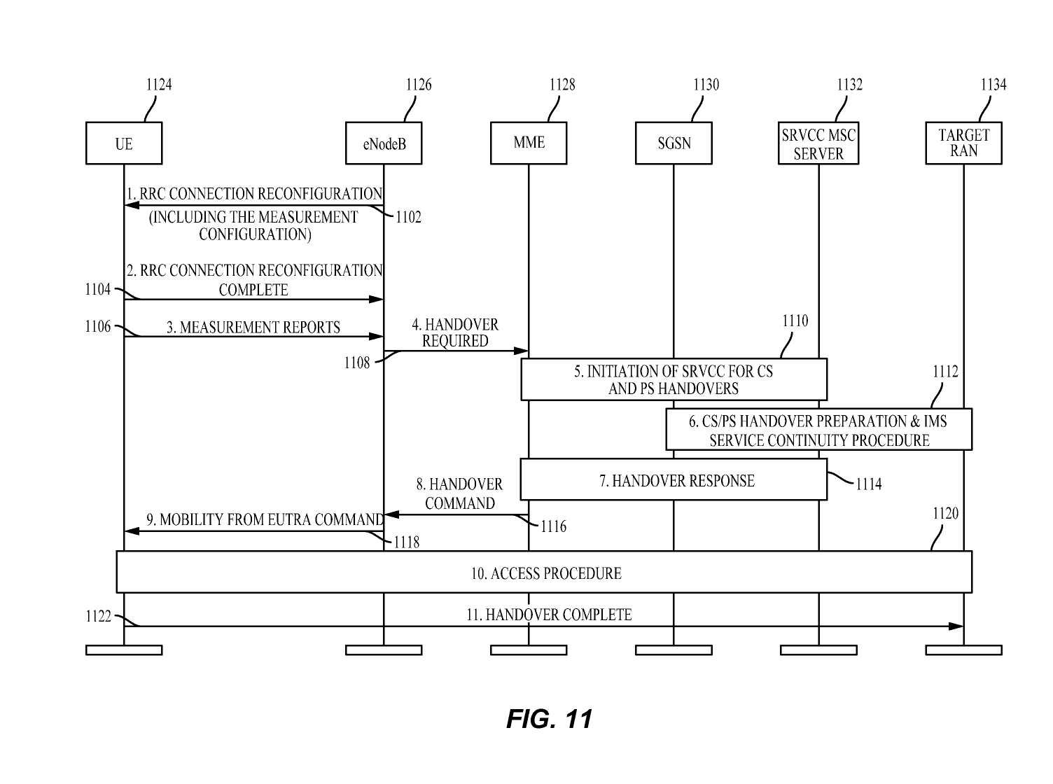

FIG. 11 is an exemplary call flow diagram illustrating a signaling procedure for handover of UE communicating according to a single radio voice call continuity (SRVCC) procedure. At time 1102, an eNodeB 1126 sends an RRC connection reconfiguration message to a UE 1124. The RRC connection configuration message may include the measurement configuration with information regarding the measurement gap resources.

At time 1104, the UE 1124 sends a message to the eNodeB 1126 indicating that RRC connection reconfiguration is complete. In addition, at time 1106, the UE 1124 also sends a measurement report to the eNodeB 1126. The eNodeB 1126 provides an indication of whether handover is desirable to the mobility management entity (MME) 1128 at time 1108. In turn, at time 1110, the MME 1128 initiates SRVCC for circuit switched (CS) and packet switched (PS) handovers. At time 1112, a serving GPRS support node (SGSN) 1130 begins CS/PS handover preparation and IMS service continuity procedures. At time 1114, the SRVCC MSC server 1132 sends a handover response message to the MME 1128. At time 1116, the MME sends a message to the eNodeB 1126 including a handover command. At time 1118, the eNodeB 1126 provides a mobility from EUTRA command (e.g., handover command) to the UE 1124. At time 1120, the UE 1124 initiates an access procedure. At time 1122, a handover complete message is sent to the target radio access network (RAN) 1134.

Handover in conventional systems may be achieved by performing IRAT measurements and/or inter frequency measurements. For example, the IRAT and/or inter frequency searches and/or measurements include LTE inter-frequency searches and measurements, 3G searches and measurements, GSM searches and measurements, etc. followed by base station identity code (BSIC) procedures. The measurements may be attempted in measurements gaps that are inadequate (e.g., short duration such as 6 ms gap) for completion of the measurement procedure. In one instance, BSIC procedures may not be accomplished because a base station identification information does not fall within the short duration measurement gap. The BSIC procedures include frequency correction channel (FCCH) tone detection and synchronization channel (SCH) decoding that are performed after signal quality measurements.

When the base station identification information falls outside of the short duration measurement gap, the UE may be unable to detect the base station identification information and may be unable synchronize with a target cell. For example, using a conventional 6 ms gap for every predefined time period (e.g., 40 ms or 80 ms), the base station identification information (e.g., FCCH and/or SCH) may not occur within the short duration measurement gap. That is, the FCCH and/or SCH do not occur during a remaining 5 ms gap after a frequency tuning period of 1 ms. If the UE is unable to detect the base station identification information communications may be interrupted. Further, repeated failed attempts by the UE may waste the UE's power.

The unpredictable failure of the FCCH/SCH to occur within the short duration measurement gap causes a variation of the IRAT measurement latency (e.g., increasing IRAT measurement latency). The failure of the FCCH/SCH to occur within the measurement gap may be due to a relative time between a serving RAT (e.g., LTE) and a neighbor RAT (e.g., GSM). The relative time impacts a time duration for the FCCH/SCH to fall into the 5 ms useful measurement gap (1 ms for frequency tuning) For example, the allocated time resources (e.g., frame timing) for the serving RAT and the neighbor RAT may be misaligned or offset, which causes failure of the FCCH/SCH to occur within the measurement gap of the serving RAT.

Because the UE may not be aware of the cause of the failure to detect the FCCH tone, for example, the UE may continue to attempt to detect the FCCH tone until an abort timer expires, which may cause delays in or interruptions to UE communications. For example, the UE may not be aware that the failure to detect the FCCH tone of the strongest frequency with the highest RSSI is due to low signal to noise ratio or FCCH occurring outside the measurement gap. As a result, the UE waits for an abort timer (e.g., 5 ms) to expire and then moves to the next strongest frequency. Waiting for expiration of the abort timer unnecessarily increase the IRAT measurement latency. However, if the UE aborts the FCCH tone detection prematurely, the UE may miss a chance of the FCCH occurring during the measurement gap.

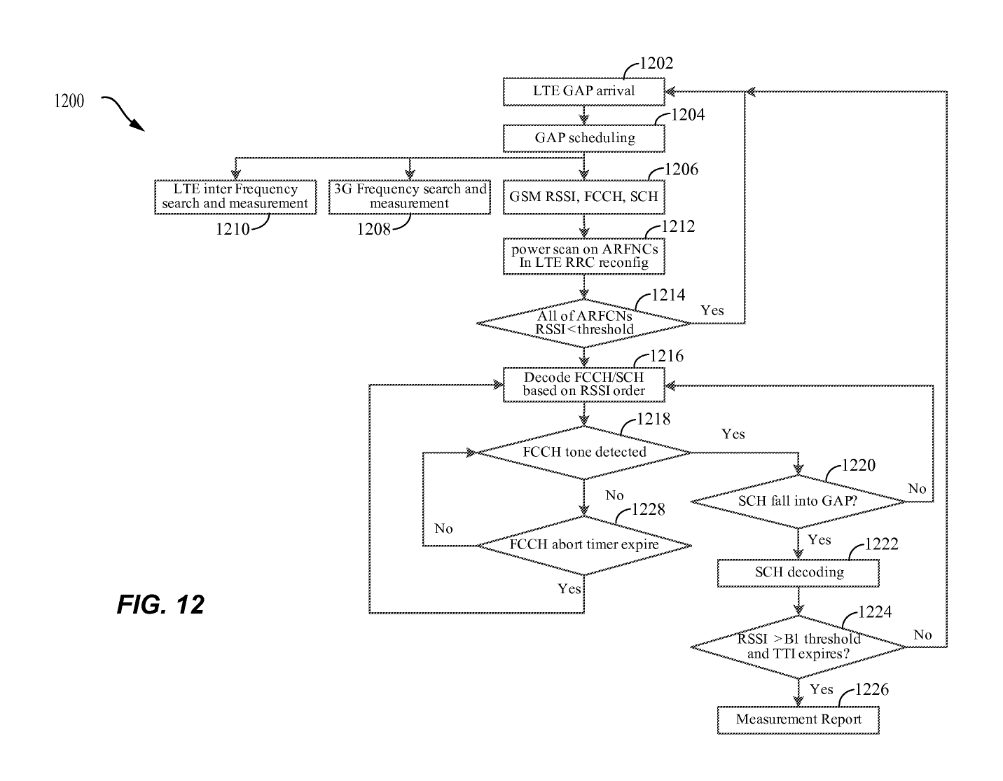

After the measurements, the UE may send a measurement report to the serving RAT. For example, the UE only sends the measurement report (e.g., B1 measurement report) after the completion of the BSIC procedures. Thus, the reporting of the results of the signal quality measurement, which occurs over a shorter period and which may occur on multiple occasions before the completion of the BSIC procedures, are delayed. Further, a transmission time interval (TTI) may expire prior to the completion of the BSIC procedures that result in an increase in latency or communication interruption. Measurement reports are transmitted to a network after the expiration of the TTI. Because the BSIC procedures are not complete, the measurement reports cannot be sent even when the TTI expires. An exemplary search and measurement procedure is illustrated in FIG. 12.

FIG. 12 is a flow diagram 1200 illustrating an example decision process for search and measurement of neighbor cells. The measurement may occur when the UE is on a first RAT (e.g., LTE) with a short duration measurement gap (e.g., 6 ms) every predefined period (e.g., 40 ms or 80 ms). The searches and measurements may include inter frequency searches and measurements and inter-radio access technology (IRAT) searches and measurements. At block 1202, measurement gap information transmitted by a network of the first RAT is received by the UE. For example, the measurement gap for LTE is a 6 ms gap that occurs every 40 or 80 ms. The UE uses the measurement gap to perform 2G/3G (e.g., TD-SCDMA and GSM) searches and measurements and LTE inter frequency searches and measurements. A search and/or measurement schedule for the neighbor cells may be received by the UE from the network, as shown in block 1204. The searches and measurements of the neighbor cells may be scheduled based on priority. For example, searches and measurements of LTE/TD-SCDMA neighbor cells or frequencies may have a higher priority than GSM neighbor cells. At blocks 1206, 1208 and 1210, the UE performs inter-radio access technology (IRAT) and/or inter frequency searches and/or measurements. The IRAT and/or inter frequency searches and/or measurements include LTE inter-frequency searches and measurements, 3G searches and measurements, GSM searches, measurements and BSIC procedures, respectively, according to the schedule.

The user equipment performs measurements by scanning frequencies (e.g., power scan), as shown in block 1212. The UE then determines whether a signal quality of a serving cell of a first RAT and the signal quality of neighbor cells meet a threshold, as shown in block 1214. For example, it is determined whether the signal qualities (e.g., RSSIs) of the neighbor cells are less than the threshold. The threshold can be indicated to the UE through dedicated radio resource control (RRC) (e.g., LTE RRC reconfiguration) signaling from the network. When the signal quality of the neighbor cells fails to meet a threshold the process returns to block 1202, in which the UE receives a next measurement gap information. However, when the signal qualities of one or more target neighbor cells meet the threshold, the UE continues to perform the BSIC procedures, as shown in block 1216. The BSIC procedures may be performed on the target neighbor cells in order of signal quality. For example, the BSIC procedures may be performed on the cell with the best signal quality, followed by the cell with the second best signal quality and so on. The BSIC procedures include frequency correction channel (FCCH) tone detection and synchronization channel (SCH) decoding) that are performed after signal quality measurements.

In block 1218, the UE may determine whether an FCCH tone is detected for a cell of the target cells (e.g., cell with best signal quality). If the FCCH tone is detected for the best cell, the UE determines whether the SCH falls into the measurement gap, as shown in block 1220. In block 1220, if the SCH does not fall into the measurement gap, the process returns to block 1216, where the UE decodes FCCH/SCH for the target cell with the second best signal quality. However, if the SCH of the target neighbor cell with the best signal quality falls into the measurement gap, the UE performs SCH decoding, as shown in block 1222. The UE then determines whether the signal quality of the target neighbor cell is greater than the threshold (e.g., B1 threshold) and whether the TTI has expired, as shown in block 1224. If the TTI expired and the signal quality of the target neighbor cell is not greater than the threshold, the process returns to block 1202, where the UE receives the measurement gap information. However, if the TTI expired and the signal quality of the target neighbor cell is greater than the threshold, the process continues to block 1226, where the UE sends a measurement report to the network. As noted, measurement reports are transmitted to a network only after the expiration of the TTI, even when the other conditions, such as ab RSSI being greater than the threshold are met.

When it is determined that the FCCH tone for the target neighbor cell is not detected at block 1218, the process continues to block 1228, where it is determined whether the FCCH abort timer expired. If the FCCH abort time is not expired, the process returns to block 1218, where the UE continues to determine whether an FCCH tone is detected for the target neighbor cell. Otherwise, when it is determined that the FCCH abort timer expired at block 1228, the process returns to block 1216 where FCCH/SCH is decoded for the next target neighbor cell.

The BSIC procedures, which include frequency correction channel (FCCH) tone detection and synchronization channel (SCH) decoding that are performed after signal quality measurements, may further cause a drain in the UE battery power. The BSIC procedures are performed to obtain timing of a target RAT, such as downlink timing, and frequency of the target RAT. For example, the UE may repeatedly attempt to detect a FCCH tone or to decode SCH when the SCH/FCCH does not fall in an allocated measurement gap. The repeated attempts further drain the UE battery power.

Power savings is especially important to ensure improved or optimum battery life for packet-switched devices (e.g., VoLTE devices) where voice calls (voice over internet protocol calls) can be frequent and long. During the voice over internet protocol calls, voice packet arrivals may exhibit traffic characteristics that are discontinuous. A discontinuous reception (DRX) mechanism may be implemented to reduce power consumption based on the discontinuous traffic characteristics of the voice packet arrivals.

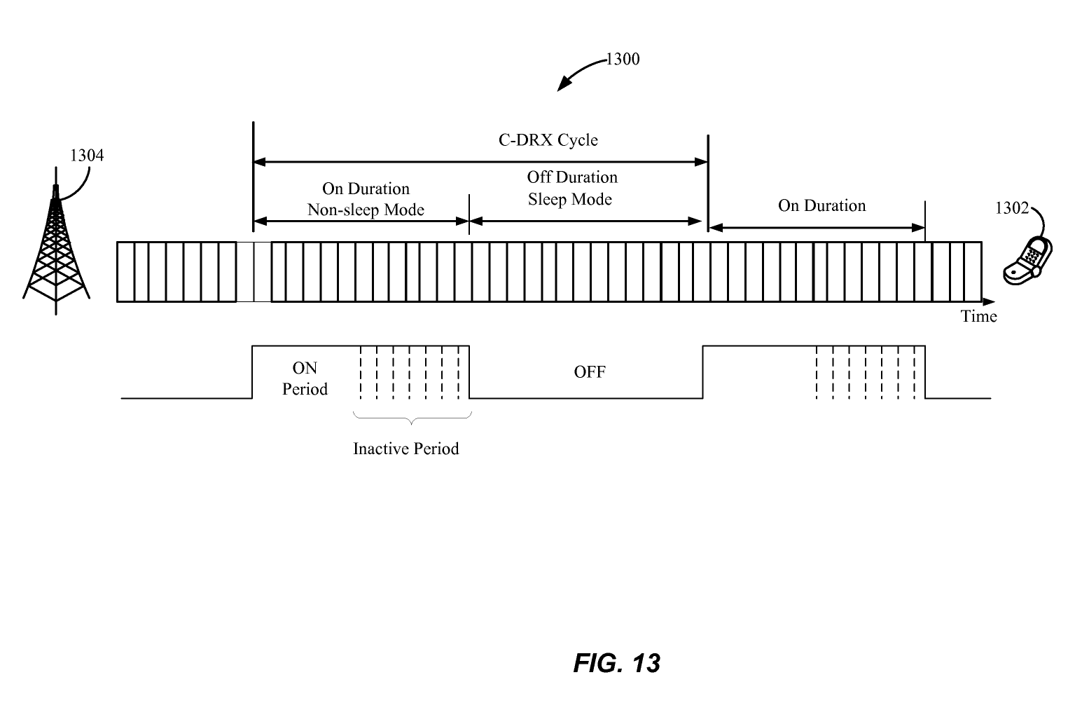

An exemplary discontinuous reception communication cycle 1300 is illustrated in FIG. 13. The discontinuous reception cycle may correspond to a communication cycle where a user equipment (UE) 1302 is in a connected state/mode (e.g., connected mode discontinuous reception (C-DRX) cycle). In the C-DRX cycle, the UE 1302 may have an ongoing communication (e.g., voice call). For example, the ongoing communication may be discontinuous because of the inherent discontinuity in voice communications. The discontinuous communication cycle may also apply to other calls (e.g., multimedia calls).

The C-DRX cycle includes a time period/duration allocated for the UE 1302 to sleep (e.g., sleep period or C-DRX off duration). The UE may sleep (e.g., enter sleep mode) during the C-DRX off duration. For example, during the sleep mode, the UE 1302 may power down some of its components (e.g., receiver or receive chain is shut down). When the UE 1302 is in the connected state (e.g., RRC connected state) and communicating according to the C-DRX cycle), power consumption may be reduced by shutting down a receiver of the UE 1302 for short periods. The C-DRX cycle also includes a time period when the UE 1302 is awake (e.g., a non-sleep mode). The non-sleep mode may include a C-DRX on period and/or a C-DRX inactive period. The C-DRX on period corresponds to periods of communication (e.g., when the user is talking). The C-DRX inactive period, however, occurs during a pause in the communication (e.g., pauses in the conversation) that occur prior to the C-DRX off duration.

The UE 1302 enters the sleep mode to conserve energy when the pause in the communication extends beyond a duration of an inactive timer. The duration of the sleep mode is defined by an inactivity timer. For example, the UE 1302 enters the sleep mode when the inactivity timer initiated at a start of the pause expires. In some implementations, a duration of the inactivity timer and corresponding C-DRX inactive period, the C-DRX on period and the C-DRX off period may be defined by a network. For example, the total C-DRX cycle may be 40 ms. The C-DRX on period may have a duration of 4 subframes, the C-DRX inactive period may have a duration of 10 subframes and the C-DRX off period may have a duration of 26 subframes.

During the non-sleep mode, such as the C-DRX inactive period, the UE 1302 monitors for downlink information such as a grant. For example, the downlink information may include physical downlink control channel (PDCCH) of each subframe. The PDCCH may carry information on resource allocation for UEs 1302 and control information for downlink channels. During the sleep mode, however, the UE 1302 skips monitoring the PDCCH to save battery power. To achieve the power savings, the serving base station (e.g., eNodeB) 1304, which is aware of the sleep and non-sleep modes of the communication cycle, skips scheduling downlink transmissions during the sleep mode. Thus, the UE does not receive downlink information during the sleep mode and can therefore skip monitoring for downlink information to save battery power.

For example, when the UE is in the connected mode and a time between the arrival of voice packets is longer than the inactivity timer (e.g., inactivity timer expires between voice activity) the UE 1302 transitions into the C-DRX off duration. A start of the inactivity timer may coincide with a start of the C-DRX inactive period of an ongoing communication. The end of the inactivity timer may coincide with a start of the C-DRX off duration or an end to the non-sleep mode provided there is no intervening reception of communication data prior to the expiration of the inactivity timer. When there is an intervening reception of communication data, the inactivity timer is reset.

In some implementations, the UE is awake during the C-DRX off duration. For example, during this time period the UE performs activities or measurement procedures such as signal quality (e.g., RSSI) measurements and/or BSIC procedures (e.g., timing (FCCH/SCH) detection/decoding) instead of falling asleep. The UE first performs the signal quality measurements (e.g., IRAT measurements) by scanning frequencies (e.g., power scan) for a list of neighbor frequencies (e.g., GSM frequencies) indicated in a radio resource control (RRC) reconfiguration message, such as LTE RRC reconfiguration message. The UE then performs the BSIC procedures (e.g., timing detection such as FCCH tone detection and SCH decoding) based on a ranked order of the frequencies. For example, the frequencies may be ranked according to their measured signal quality. The signal quality measurements and the BSIC procedures may be performed until the time period allocated for the sleep mode ends. In some implementations, however, the duration of the sleep mode is insufficient for the measurement procedures. For example, the duration of the sleep mode may be too short to complete FCCH tone detection and/or SCH decoding, which may repeat periodically (e.g., every 10 to 11 frames). Therefore, solutions for performing measurement during the time period allocated for the sleep mode is desirable.

In one aspect,

The solutions become even more important because e.g. Performing the measurement procedures (e.g., IRAT measurements and/or inter frequency measurements) during the C-DRX off duration reduces the battery life. Furthermore, the battery life may be unnecessarily degraded, when the IRAT measurements and/or inter frequency measurements are performed when a signal quality of a current serving cell fails to meet a measurement reporting condition. For example, the measurement reporting condition is not met when the signal quality of the serving cell is below a threshold indicated by a network supporting the serving cell. The threshold may be established in accordance with event B2 procedures. The measurement reporting may be further interrupted when communication data arrives during the measurement procedures including the measurement reporting.

For example, when communication data (e.g., application data) arrives in the UE buffer, the measurement procedure is interrupted in favor of the UE sending a scheduling request and monitoring for a grant channel. The application data may originate from an application running on the UE. The application data may include background activities that are not central to maintaining a call (e.g., an ongoing connected state call) on the UE. For example, the application data includes background activities such as periodic beat or keep alive message that will not cause a call failure.

In general, when the conditions of the measurements are satisfied and the TTI timer expires, the UE may send a measurement report using a received grant. The measurement report may be incomplete because of the interruption in the measurement procedures. After the UE sends the measurement report, measurement procedures (e.g., signal quality measurements and BSIC procedures) are suspended. The suspension of the signal quality measurements and BSIC procedures may cause a call drop when the serving cell (e.g., LTE serving cell) signal quickly degrades. Because of the arrival of the application data at the UE buffer during the C-DRX off duration, the signal quality measurements and BSIC procedures are suspended. In lieu of the suspension of the signal quality measurements and BSIC procedures, the UE stays awake for other activities (e.g., monitor for background activities), rather than performing signal quality measurements and BSIC procedures that will allow the UE to handover from an undesirable serving cell to a desirable serving cell. Failing to perform signal quality measurements and BSIC procedures may result in a call drop when the serving cell signal quality is significantly degraded.

### Measurement Procedures During Connected Mode Discontinuous Reception Cycle Based on Blocking Low Priority Data Activities

Aspects of the present disclosure are directed to improving measurement procedures during a communication cycle (e.g., a connected mode discontinuous reception cycle (C-DRX cycle)). A user equipment (UE) may enter a C-DRX off duration of the C-DRX cycle. During this time period, the UE may sleep to save the battery life, or perform measurement procedures. In some instances, the sleeping or measurement procedures may be interrupted by background activities. For example, the UE cannot enter the C-DRX off duration when the background activities are ongoing. Additionally, the measurement procedures are interrupted during the C-DRX off duration by ongoing background activities.

In one aspect of the present disclosure, the UE stops or suspends the background activities on a serving cell of the serving RAT so that the UE enters the C-DRX off duration without interruptions. The background activities are stopped or suspended based on a signal quality of the serving RAT. In some aspects, the background activities may be stopped or suspended in favor of performing the measurement procedures during the time period allocated for the sleep mode. For example, the background activities are stopped when a signal quality of a serving RAT is below one or more predefined thresholds. The serving RAT includes the serving cell of the serving RAT and one or more neighbor cells of the serving RAT. For example, the signal quality of the serving RAT and the signal quality of each of the neighbor RATs are compared to the one or more predefined thresholds.

The UE stops or suspends the background activities when the signal quality of each of the serving and the one or more neighbor cells of the serving RAT are below the threshold. In one aspect, the serving RAT includes a serving cell and at least one intra frequency and/or inter frequency neighbor cell. In this case, the measurement procedures can be performed without interruption from the background activities. However, at a certain threshold (e.g., a low predefined threshold or a high predefined threshold), the UE benefits by sleeping during the time period allocated for sleeping, rather than performing measurement procedures or being interrupted by the background activities.

Performing measurements when the signal quality of the serving RAT is very low, such as below the low predefined threshold, degrades power of a UE battery as the UE attempts to measure a low quality signal that may not be used further. Under these conditions, the UE benefits by discontinuing the measurement procedures and entering a sleep mode to conserve power.

Similarly, performing measurements when the signal quality of the serving RAT is very high, such as above the high predefined threshold, unnecessarily degrades the UE battery power as repeated measurements of a sufficiently strong signal may be unnecessary. In this case, the UE can stay on the strong serving RAT and does not perform measurements to enable hand over to a neighbor cell. The predefined threshold may be independently set by the UE. The serving RAT may include frequencies of the serving cell and frequencies of one or more neighbor cells of the serving RAT. The measurements may be performed on the frequencies of the serving and neighbor cells of the serving RAT. For example, when the signal quality of the frequencies of the serving and neighbor cells of the serving RAT is above the low predefined threshold, below the high predefined threshold and/or between the low predefined threshold and the high predefined threshold, the UE may suspend background activities during the C-DRX off duration in order to perform the measurement procedures.

The background activities may include periodic or heartbeat messages, keep alive messages or any other communication information that is not critical to maintaining a call. For example, the keep alive message is a message sent by one device to another to check that the link between the two is operating, or to prevent the link from being broken. The heartbeat message is a message sent from an originator to a destination that enables the destination to identify if and when the originator fails or is no longer available.

These aspects of the present disclosure reduce delays associated with IRAT measurements and also reduce call drops associated with SRVCC communications caused by background activities.

Other aspects of the present disclosure are directed to conserving battery power during the ongoing communication cycle (e.g., connected mode discontinuous reception cycle (C-DRX). In yet another aspect of the disclosure, a user equipment (UE) determines whether to perform measurement procedures (e.g., IRAT measurements and/or inter frequency measurements) during the C-DRX off duration based on a signal quality of a serving cell and/or signal quality of one or more neighbor cells. The serving cell and the one or more neighbor cells may belong to a same RAT or different RAT. For example, each of the serving cell and the one or more neighbor cells may belong to a first RAT (e.g., LTE). Alternatively, the serving cell may belong to the first RAT and each of the one or more neighbor cells may belong to a different RAT. When the UE determines it is to perform the measurement procedures, the UE may prevent disruptions in the measurement procedures. For example, the UE may prevent interruptions during the measurement procedures by stopping or suspending background activities as discussed.

To determine whether to perform the measurement procedures during the C-DRX off duration, the UE detects the signal quality of the serving cell of a serving RAT and the signal quality of the neighbor cell(s) of the serving RAT. The UE then determines whether to perform measurement procedures on a non-serving RAT during the C-DRX off duration based on the detected signal quality of the serving RAT. For example, the UE measures the signal quality of a frequency of the serving cell and each of the frequencies of the neighbor cells to determine whether each of the signal qualities meets a threshold set by the UE. When each of the detected signal qualities of the serving cell and the neighbor cell(s) of the serving RAT are low (e.g., below the low predefined threshold) the UE prevents the IRAT measurements and/or inter frequency measurements. In this case, the UE may fall asleep during the C-DRX off duration to save battery power instead of performing the IRAT measurements and/or inter frequency measurements.

However, when the detected signal quality of the serving cell and the neighbor cell(s) of the serving RAT are above the low predefined threshold and/or below the high predefined threshold, the UE performs the IRAT measurements and/or inter frequency measurements during the C-DRX off duration.

As noted, performing measurements when the signal quality of the serving RAT is very low, such as below the low predefined threshold, degrades power of a UE battery. Under these conditions, the UE benefits by discontinuing measurements and enter a sleep mode. Similarly, performing measurements when the signal quality of the serving RAT is very high, such as above the high predefined threshold, unnecessarily degrades battery power. In this case, the UE can stay on the strong serving RAT and does not perform measurements for handover to a neighbor cell.

The UE may further determine whether to perform measurement procedures (e.g., IRAT measurements and/or inter frequency measurements) on a non-serving RAT during the C-DRX off duration based on a gap period allocated for the measurements. In one aspect of the disclosure, the measurement gap period may be allocated to occur during a C-DRX on duration. The measurement procedures may be performed in the measurement gap during the C-DRX on duration and/or in conjunction with the measurement procedures performed during the C-DRX off duration. For example, the UE determines whether the measurement gap period is sufficient to perform a signal quality measurement of the non-serving RAT and/or detect timing (e.g., perform a BSIC procedure) of the non-serving RAT. In one aspect, the sufficiency of the measurement gap is determined based on whether the UE can detect the timing of the non-serving RAT. For example, the sufficiency of the measurement gap is determined based on, for example, whether the UE can perform frequency correction channel (FCCH) tone detection and/or synchronization channel (SCH) decoding. When the measurement gap is sufficient, the UE performs the measurement procedures (e.g., IRAT measurements and/or inter frequency measurements) on a non-serving RAT during the measurement gap. Otherwise, when the measurement gap is insufficient, the UE does not perform the measurement procedures in the measurement gap.

In some aspects of the disclosure, the UE prevents the measurement procedures during the C-DRX off duration when the UE determines that the measurement gap period allocated during the non-sleep mode of the ongoing communication is sufficient for the measurement procedures (e.g., timing detection). For example, the UE performs the BSIC procedures or timing detection (e.g., FCCH detection and/or SCH decoding) during the non-sleep mode when the SCH and FCCH occur during the allocated measurement gap period. In this case, the UE may fall asleep during the time period allocated for the sleep mode to save battery power instead of performing the measurement procedures. The UE, however, performs the measurement procedures during the time period allocated for sleep mode when the UE determines that the measurement gap period allocated during the non-sleep mode is insufficient. For example, the UE performs the BSIC procedures (e.g., FCCH detection and/or SCH decoding) during the sleep mode when the SCH and FCCH occur during the sleep mode.

In addition to the sufficiency of the measurement gap period, the UE may determine whether to perform the measurement procedures on the non-serving RAT during the C-DRX off duration based on a number of the neighbor cells of the serving RAT. For example, the UE may not perform measurement procedures during the C-DRX off duration when the number of neighbor cells of the serving RAT is small (e.g., below a threshold independently set by the UE).

In another aspect of the disclosure, when the UE determines that the measurement gap period overlaps the non-sleep mode and the C-DRX off duration, the UE determines whether to perform the BSIC procedures (e.g., FCCH detection and/or SCH decoding) during the time period allocated for the sleep mode. For example, if the FCCH and the SCH occur during the non-sleep mode portion of the measurement gap period, the UE performs the BSIC procedures during the non-sleep mode while the UE sleeps during the C-DRX off duration. Otherwise, the UE performs the BSIC procedures during the C-DRX off duration when the FCCH and the SCH does not occur during the non-sleep mode portion of the measurement gap period.

In one aspect, when the C-DRX off duration coincides with the C-DRX off duration and the non-sleep period frequency correction channel (FCCH) tone detection and/or synchronization channel (SCH) decoding are performed. In another aspect, inter radio access technology (IRAT) measurement is performed during the C-DRX off duration in the C-DRX cycle when the latency specification of background data is longer than then time interval between an uplink data activity and the C-DRX on duration of the next C-DRX cycle.

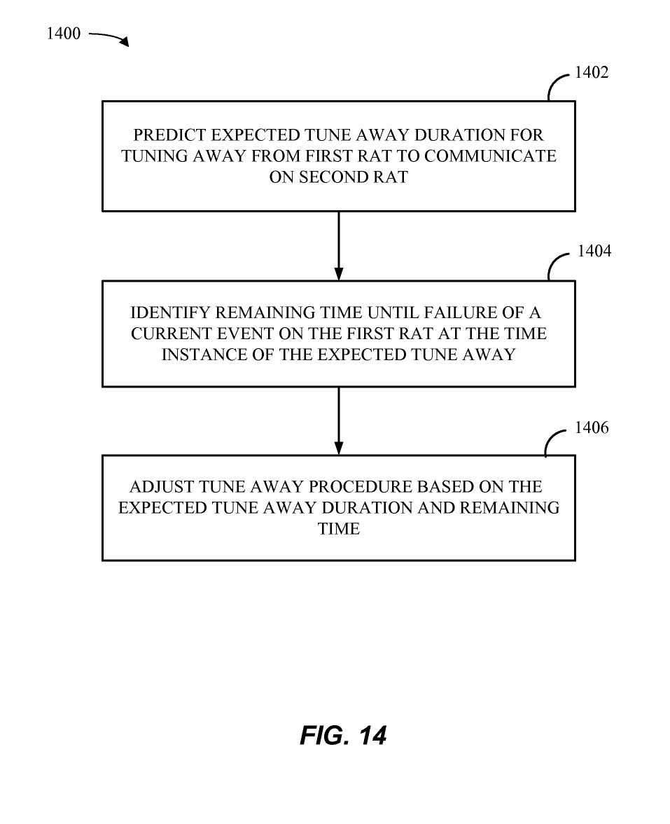

FIG. 14 shows a wireless communication method 1400 according to one aspect of the disclosure. At block 1402, a user equipment (UE) predicts an expected tune away duration for tuning away from a first radio access technology (RAT) to communicate on a second RAT. At block 1404, the UE identifies a remaining time until failure of a current event on the first RAT at the time instance of the expected tune away. At block 1406, the UE adjusts a tune away procedure based on the expected tune away duration and the remaining time.

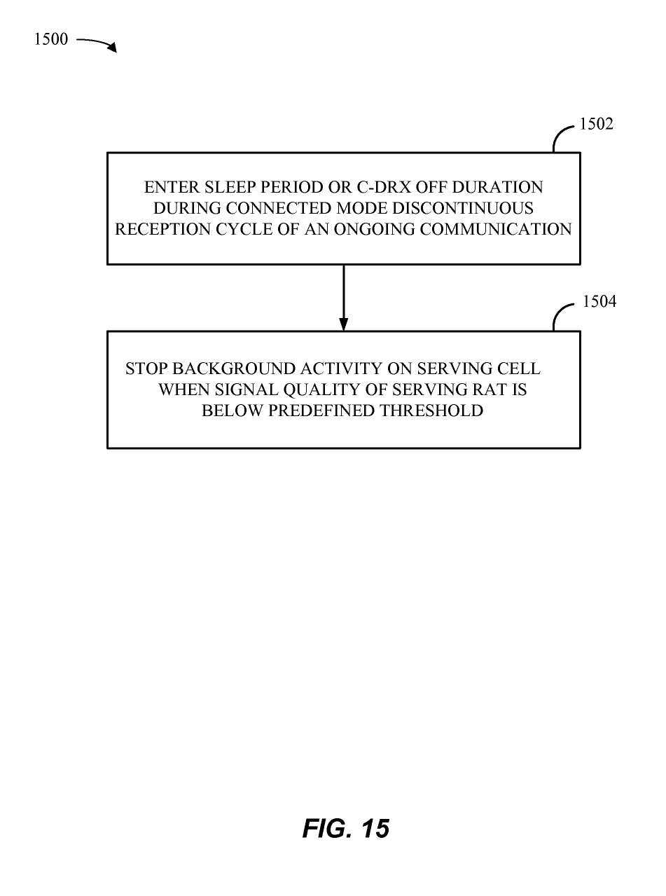

FIG. 15 shows a wireless communication method 1500 according to one aspect of the disclosure. At block 1502, a user equipment (UE) enters a sleep period or C-DRX off duration during a connected mode discontinuous reception cycle of an ongoing communication. The UE then stops background activity on a serving cell when the signal quality of the serving RAT is below a predefined threshold, as shown at block 1504.

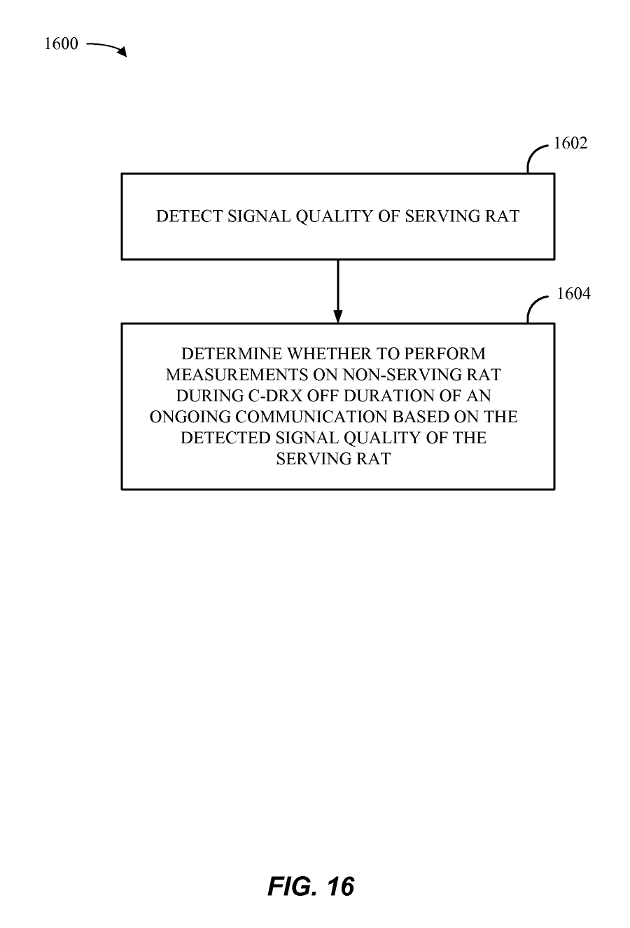

FIG. 16 shows a wireless communication method 1600 according to one aspect of the disclosure. At block 1602, the UE detects a signal quality of a serving radio access technology (RAT). The UE then determines whether to perform measurements on a non-serving RAT during a C-DRX off duration of an ongoing communication based on the detected signal quality of the serving RAT, as shown at block 1604.

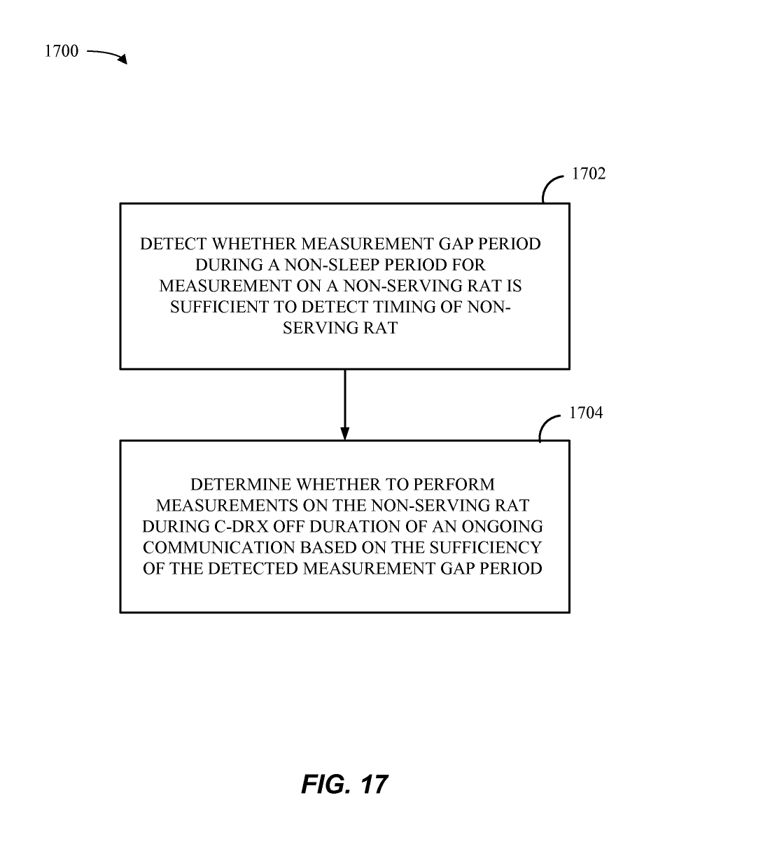

FIG. 17 shows a wireless communication method 1700 according to one aspect of the disclosure. At block 1702, the UE detects whether a measurement gap period during a non-sleep period for measurement of a non-serving radio access technology (RAT) is sufficient to detect timing of the non-serving RAT. The UE then determines whether to perform measurements on the non-serving RAT during a C-DRX off duration of an ongoing communication based on the sufficiency of the detected measurement gap period, as shown at block 1704.

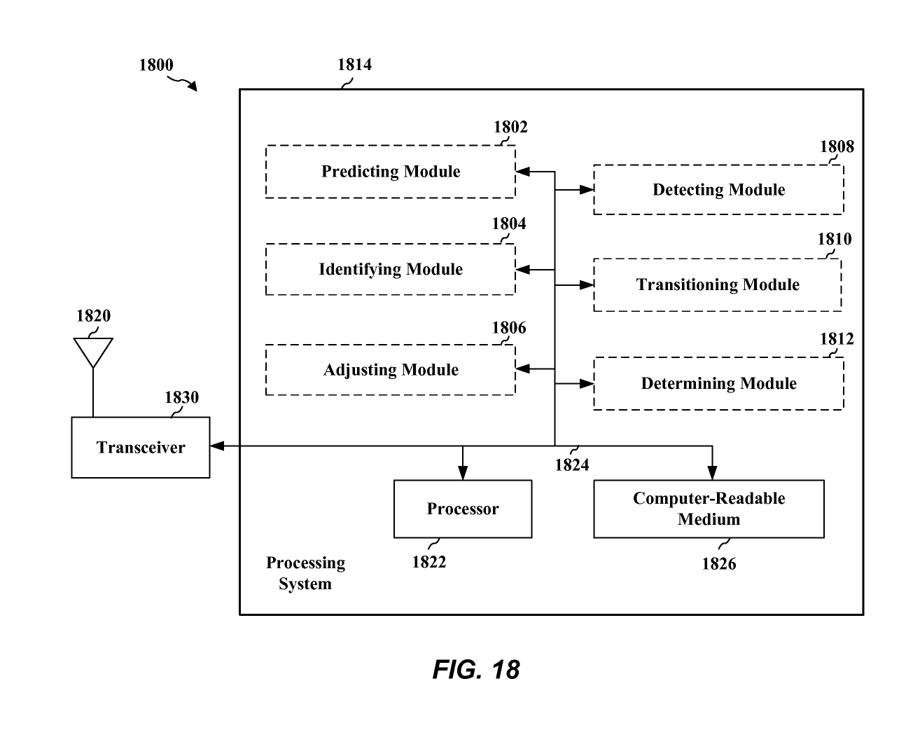

FIG. 18 is a diagram illustrating an example of a hardware implementation for an apparatus 1800 employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware modules, represented by the processor 1822 the modules 1802, 1804, 1806, 1808, 1810, 1812 and the non-transitory computer-readable medium 1826. The bus 1824 may also link various other circuits such as timing sources, peripherals, voltage regulators, and power management circuits, which are well known in the art, and therefore, will not be described any further.

The apparatus includes a processing system 1814 coupled to a transceiver 1830. The transceiver 1830 is coupled to one or more antennas 1820. The transceiver 1830 enables communicating with various other apparatus over a transmission medium. The processing system 1814 includes a processor 1822 coupled to a non-transitory computer-readable medium 1826. The processor 1822 is responsible for general processing, including the execution of software stored on the computer-readable medium 1826. The software, when executed by the processor 1822, causes the processing system 1814 to perform the various functions described for any particular apparatus. The computer-readable medium 1826 may also be used for storing data that is manipulated by the processor 1822 when executing software.

The processing system 1814 includes a predicting module 1802 for predicting an expected tune away duration for tuning away from a first radio access technology (RAT) to communicate on a second RAT. The processing system 1814 also includes an identifying module 1804 for identifying a timer for failure of a current event on the first RAT. The processing system 1814 may also include an adjusting module 1806 for adjusting a tune away procedure based on the expected tune away duration and the timer. Further, the processing system 1814 includes a transitioning module 1810 for entering a C-DRX off duration and stopping background activity on a serving cell when a signal quality of the serving RAT is below a predefined threshold.

The processing system 1814 may include a detecting module 1808 for detecting a signal quality of a serving RAT. Furthermore, the processing system 1814 includes a determining module 1812 for determining whether to perform measurements on a non-serving RAT during a sleep mode of an ongoing communication based on the detected signal quality. The determining module 1812 also determines whether to perform measurements on the non-serving RAT during a sleep mode of an ongoing communication based on the sufficiency of the detected gap period.

The modules 1802, 1804, 1806, 1808, 1810 and 1812 may be software modules running in the processor 1822, resident/stored in the computer-readable medium 1826, one or more hardware modules coupled to the processor 1822, or some combination thereof. The processing system 1814 may be a component of the UE 750 of FIG. 7 and may include the memory 760, and/or the controller/processor 759.

In one configuration, an apparatus such as a UE 750 is configured for wireless communication including means for predicting. In one aspect, the predicting means may be the receive processor 756, the controller/processor 759, the memory 760, the wireless communication module 791, the predicting module 1802, and/or the processing system 1814 configured to perform the aforementioned means. In one configuration, the means functions correspond to the aforementioned structures. In another aspect, the aforementioned means may be a module or any apparatus configured to perform the functions recited by the aforementioned means.

The UE 750 is also configured to include means for identifying. In one aspect, the identifying means may include the antenna 752, antenna 1820, the receiver 754, the transceiver 1830, the receive processor 756, the controller/processor 759, the memory 760, the identifying module 1804, and/or the processing system 1814 configured to perform the functions recited by the identifying means. In one configuration, the means and functions correspond to the aforementioned structures. In another aspect, the aforementioned means may be a module or any apparatus configured to perform the functions recited by the searching means.

The UE 750 is also configured to include means for adjusting. In one aspect, the adjusting means may include the receive processor 756, the controller/processor 759, the memory 760, the wireless communication module 791, the predicting module 1802, and/or the processing system 1814 configured to perform the aforementioned means. In one configuration, the means and functions correspond to the aforementioned structures. In another aspect, the aforementioned means may be a module or any apparatus configured to perform the functions recited by the suspending means.

The UE 750 is also configured to include means for detecting. In one aspect, the detecting means may include the antenna 752, the antenna 1820, the receiver 754, the transceiver 1830, the receive processor 756, the controller/processor 759, the memory 760, the identifying module 1804, and/or the processing system 1814 configured to perform the functions recited by the detecting means. In one configuration, the means and functions correspond to the aforementioned structures. In another aspect, the aforementioned means may be a module or any apparatus configured to perform the functions recited by the searching means.

The UE 750 is also configured for wireless communication including means for transitioning. In one aspect, the transitioning means may be the receive processor 756, the controller/processor 759, the memory 760, transitioning module 1810, and/or the processing system 1814 configured to perform the functions recited by the transitioning means. In one configuration, the means functions correspond to the aforementioned structures. In another aspect, the aforementioned means may be a module or any apparatus configured to perform the functions recited by the aforementioned means.

The UE 750 is also configured for wireless communication including means for determining. In one aspect, the determining means may be the receive processor 756, the controller/processor 759, the memory 760, the wireless communication module 791, the predicting module 1802, and/or the processing system 1814 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE, TD-SCDMA and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
entering a connected mode discontinuous reception cycle (C-DRX) off duration during a C-DRX cycle of an ongoing communication; and
stopping background activity until a start of a C-DRX on duration of the next C-DRX cycle when a signal quality of a serving radio access technology (RAT) is below a predefined threshold.

2. The method of claim 1, in which the serving RAT comprises a serving cell and at least one intra frequency and/or inter frequency neighbor cell.

3. The method of claim 1, further comprising performing inter radio access technology (IRAT) measurement during the C-DRX off duration in the C-DRX cycle when latency specification of background data is longer than a time interval between an uplink data activity and the C-DRX on duration of the next C-DRX cycle.

4. The method of claim 1, further comprising:
detecting the signal quality of the serving radio access technology (RAT); and
determining whether to perform measurements on a non-serving RAT during the C-DRX off duration based at least in part on the detected signal quality of the serving RAT.

5. The method of claim 1, further comprising:
detecting whether a measurement gap period during a non-sleep period for measuring a non-serving RAT is sufficient to detect timing and/or frequency of the non-serving RAT; and
determining whether to perform measurements on the non-serving RAT during the C-DRX off duration based at least in part on sufficiency of the measurement gap period.

6. The method of claim 5, further comprising detecting the timing and/or frequency during the C-DRX off duration when a user equipment (UE) determines that the measurement gap period during the non-sleep period of the ongoing communication is insufficient for the timing and/or frequency detection.

7. The method of claim 6, in which detecting the timing and/or frequency comprises frequency correction channel (FCCH) tone detection and/or synchronization channel (SCH) decoding and in which the measurement gap period during the non-sleep period is insufficient for the timing and/or frequency detection when an FCCH and/or SCH for the timing and/or frequency detection coincides with the C-DRX off duration.

8. The method of claim 5, further comprising detecting the timing and/or frequency during the non-sleep period when a user equipment (UE) determines the measurement gap period during the non-sleep period is sufficient for the timing and/or frequency detection.

9. The method of claim 8, in which detecting the timing and/or frequency comprises frequency correction channel (FCCH) tone detection and/or synchronization channel (SCH) decoding and in which the measurement gap period during the non-sleep period is sufficient for the timing and/or frequency detection when an FCCH and/or SCH for the timing and/or frequency detection coincides with the measurement gap period.

10. The method of claim 5, in which detecting the timing and/or frequency comprises frequency correction channel (FCCH) tone detection and/or synchronization channel (SCH) decoding, in which the C-DRX off duration coincides with the C-DRX off duration and the non-sleep period.

11. The method of claim 10, further comprising determining whether to perform the timing and/or frequency detection during the measurement gap period or the C-DRX off duration based at least in part on whether an FCCH and/or SCH for the timing and/or frequency detection coincides with the C-DRX off duration or the measurement gap period.

12. An apparatus for wireless communication, comprising:
means for entering a connected mode discontinuous reception cycle (C-DRX) off duration during a C-DRX cycle of an ongoing communication; and
means for stopping background activity until a start of a C-DRX on duration of the next C-DRX cycle when a signal quality of a serving radio access technology (RAT) is below a predefined threshold.

13. The apparatus of claim 12, in which the serving RAT comprises a serving cell and at least one intra frequency and/or inter frequency neighbor cell.

14. The apparatus of claim 12, further comprising means for performing inter radio access technology (IRAT) measurement during the C-DRX off duration in the C-DRX cycle when latency specification of background data is longer than a time interval between an uplink data activity and the C-DRX on duration of the next C-DRX cycle.

15. The apparatus of claim 12, further comprising:
means for detecting the signal quality of the serving radio access technology (RAT); and
means for determining whether to perform measurements on a non-serving RAT during the C-DRX off duration based at least in part on the detected signal quality of the serving RAT.

16. An apparatus for wireless communication, comprising:
a memory; and
a transceiver coupled to at least one processor, in which the at least one processor is configured:
to cause a user equipment (UE) to enter a connected mode discontinuous reception cycle (C-DRX) off duration during a C-DRX cycle of an ongoing communication; and
to stop background activity until a start of a C-DRX on duration of the next C-DRX cycle when a signal quality of a serving radio access technology (RAT) is below a predefined threshold.

17. The apparatus of claim 16, in which the serving RAT comprises a serving cell and at least one intra frequency and/or inter frequency neighbor cell.

18. The apparatus of claim 16, in which the at least one processor is further configured to perform inter radio access technology (IRAT) measurement during the C-DRX off duration in the C-DRX cycle when latency specification of background data is longer than a time interval between an uplink data activity and the C-DRX on duration of the next C-DRX cycle.

19. The apparatus of claim 16, in which the at least one processor is further configured:
to detect the signal quality of the serving radio access technology (RAT); and
to determine whether to perform measurements on a non-serving RAT during the C-DRX off duration based at least in part on the detected signal quality of the serving RAT.

20. The apparatus of claim 16, in which the at least one processor is further configured:
to detect whether a measurement gap period during a non-sleep period for measuring a non-serving RAT is sufficient to detect timing and/or frequency of the non-serving RAT; and
to determine whether to perform measurements on the non-serving RAT during the C-DRX off duration based at least in part on sufficiency of the measurement gap period.

21. The apparatus of claim 20, in which the at least one processor is further configured to detect the timing and/or frequency during the C-DRX off duration when the UE determines that the measurement gap period during the non-sleep period of the ongoing communication is insufficient for a timing detection.

22. The apparatus of claim 21, in which the at least one processor is further configured detect the timing and/or frequency by frequency correction channel (FCCH) tone detection and/or synchronization channel (SCH) decoding and in which the measurement gap period during the non-sleep period is insufficient for the timing and/or frequency detection when an FCCH and/or SCH for the timing and/or frequency detection coincides with the C-DRX off duration.

23. The apparatus of claim 20, in which the at least one processor is further configured to detect the timing and/or frequency during the non-sleep period when the user equipment (UE) determines the measurement gap period during the non-sleep period is sufficient for a timing detection.

24. The apparatus of claim 23, in which the at least one processor is further configured to detect the timing and/or frequency by frequency correction channel (FCCH) tone detection and/or synchronization channel (SCH) decoding and in which the measurement gap period during the non-sleep period is sufficient for the timing and/or frequency detection when an FCCH and/or SCH for the timing and/or frequency detection coincides with the measurement gap period.

25. The apparatus of claim 20, in which the at least one processor is further configured to detect the timing and/or frequency comprises frequency correction channel (FCCH) tone detection and/or synchronization channel (SCH) decoding, in which the C-DRX off duration coincides with the C-DRX off duration and the non-sleep period.

26. The apparatus of claim 25, in which the at least one processor is further configured to determine whether to perform the timing and/or frequency detection during the measurement gap period or the C-DRX off duration based at least in part on whether an FCCH and/or SCH for the timing and/or frequency detection coincides with the C-DRX off duration or the measurement gap period.

27. A non-transitory computer-readable medium having program code recorded thereon, the program code comprising:
program code to cause a user equipment to enter a connected mode discontinuous reception cycle (C-DRX) off duration during a C-DRX cycle of an ongoing communication; and
program code to stop background activity until a start of a C-DRX on duration of the next C-DRX cycle when a signal quality of a serving radio access technology (RAT) is below a predefined threshold.

28. The computer-readable medium of claim 27, in which the serving RAT comprises a serving cell and at least one intra frequency and/or inter frequency neighbor cell.

29. The computer-readable medium of claim 27, further comprising program code to perform inter radio access technology (IRAT) measurement during the C-DRX off duration in the C-DRX cycle when latency specification of background data is longer than a time interval between an uplink data activity and the C-DRX on duration of the next C-DRX cycle.

30. The computer-readable medium of claim 27, further comprising:
program code to detect the signal quality of the serving radio access technology (RAT); and
program code to determine whether to perform measurements on a non-serving RAT during the C-DRX off duration based at least in part on the detected signal quality of the serving RAT.
